(19) United States
(12) Patent Application Publication
(10) Pub. No.: US 2004/0007868 A1
(43) Pub. Date: Jan. 15, 2004

(54) Methods and devices for identifying individual products

(75) Inventor: Evan Alan Werling, Indianapolis, IN (US)

Correspondence Address: LEAGRE CHANDLER & MILLARD LLP, 1400 FIRST INDIANA PLAZA, 135 NORTH PENNSYLVANIA STREET, INDIANAPOLIS, IN, 46204-2415, US

(73) Assignees: Sue Ann Werling, Plainfield, IN; Evan Alan Werling, Plainfield, IN

(21) Appl. No.: 10/192,664

(22) Filed: Jul. 10, 2002

(51) Int. Cl. B42D 15/00

(52) U.S. Cl. 283/67

(57) ABSTRACT

A book covering is provided that includes a front cover portion and a back cover portion connected to the front cover portion by a spine. A unique identifier is printed on the book covering. A surface coating can be disposed over portions of the covering. In some embodiments, the unique identifier is printed on the back cover portion. In other embodiments, the unique identifier is a bar code. Methods for printing book coverings, product packaging and products are also provided and include providing a printing press having means for printing variable data so that the unique identifier can be printed on-press. Methods for determining whether a refund should be issued for a book or product are also provided. The methods include correlating the unique identifier with information and upon receiving a returned product, determining the price based on the unique identifier to determine the amount of refund to issue, if any.

### FIELD OF THE INVENTION

The present invention relates to the fields of publishing, printing, manufacturing and retail.

### BACKGROUND OF THE INVENTION

In the fields of publishing and manufacturing, products are often returned for refund or credit. In particular, book publishers have noticed a growing problem in determining the proper refund (if any) to be given for returned books. One cause of the problem is that the same product can be sold at varying prices, and/or given away at no charge to the recipient. For example, publishers often provide free books in the hopes that the publisher's books will be selected for use by the educational community. Publishers, manufacturers and retailers believe that some of these samples are being returned for credit as if they had been purchased. Another aspect of the problem is that products are sold at different prices in different markets, especially overseas. Currently, when books are returned to publishers for credit, there is no way of determining the original price paid for the book, or to whom the book was sold. In addition, publishers suspect that some books are being sold by unauthorized sources or are being copied (pirated). These problems are becoming a major concern to the publishers, since most book data is now transferred electronically, in digital form, rather than in the form of film. These electronic data files are easy to transfer throughout the world, with little or no control by the publishers to prevent these transfers, which can result in unauthorized printings of their materials.

It would be desirable to have means to identify each product before it is shipped, so that upon return for credit it could be verified that each individual product had been purchased and then determine the appropriate refund, if any. Such capability could save publishers, manufacturers and retailers significant expense.

Several suggestions have been considered but rejected because they are not feasible for large-scale printing and distribution. For example, concepts such as adding a label with a unique number or a registered hologram would solve the problem by uniquely identifying each book or each set of books, such as those sold at a particular price or those given away as samples. Unfortunately, such a solution would add another step in the book distribution process, which would result in increased cost and delay. In addition, it would be difficult and expensive to monitor employees to ensure that this manual step was accomplished for each and every book.

It would be more feasible to add such labels at the printing stage, however publishers typically do not have sufficient information to accurately determine the proper quantities needed within each distribution category at the printing stage. And, when the publisher's projections were incorrect, which would be typical, publishers would have too many of one book segment and not enough of the others.

This publishing challenge is part of the greater problem suffered by all manufacturers and retail operations, which also includes fraud and occasionally, mistakes. Therefore, a need has remained for methods for neutralizing these problems.

### SUMMARY OF THE DISCLOSURE

The present invention provides book coverings and methods for printing book coverings and product packaging that have unique identifiers and methods for determining the proper refund for books and other products. In one embodiment, a book covering is provided that includes a front cover portion and a back cover portion connected to the front cover portion by a spine. A unique identifier is printed on the book covering and a surface coating is disposed over at least a portion of the front cover, the spine, at least a portion of the back cover and the unique identifier. In one embodiment, the surface coating is a film lamination. In a particular aspect, the unique identifier is printed on the back cover portion. In still another aspect, the unique identifier is a bar code.

Methods for printing a book covering of this invention are also provided. In one embodiment, the method includes the steps of providing a printing press having means for printing variable data; employing the printing press to print book cover indicia on stock; printing a unique identifier on the stock with the means; and covering portions of the stock with a surface coating after the employing step and the printing step. In a specific embodiment, the means includes a variable data printing apparatus operatively engaged to the printing press.

In yet another aspect, the invention provides methods for printing a run of book coverings. The methods include the steps of providing a printing press assembly having a printing press and a variable data printing apparatus operatively engaged to the printing press; providing sheets of stock employing the printing press to print book cover indicia on each sheet of stock; printing at least one unique identifier on each sheet of the stock with the variable data printing apparatus; and coating the stock with a surface coating after the employing step and the printing step. The invention also contemplates using a web of stock wherein the web has designated portions designated to correspond to individual book coverings.

In yet another aspect, methods for determining whether a refund should be issued for a book, are provided. One such method includes the steps of: binding a book covering of this invention to text material to create a book; recording the unique identifier; correlating the unique identifier with a price to be charged to a customer; shipping the book after the recording step; and upon receiving a returned book, determining the price based on the unique identifier to determine the amount of refund to issue, if any. In certain embodiments, the shipping step occurs after the correlating step but in other embodiments, the shipping step occurs before the correlating step. The methods also include correlating the unique identifier to customer information and/or payment information.

The present invention provides means for enhancing financial control over products by creating solutions to problems caused by fraud and mistake. The invention also provides many opportunities for obtaining information about customers and purchasing habits and other important marketing information. The methods of this invention can be applied to product packages to print unique identifiers that manufacturers and retailers can employ.

Other features and advantages of the present invention will become readily apparent from the following detailed description, the appended claims and the accompanying drawings. It is to be understood that both the foregoing general description and the following detailed description are exemplary and provided for purposes of explanation only, and are not restrictive of the invention, as claimed.

### BRIEF DESCRIPTIONS OF DRAWINGS

FIG. 1 is an elevational view of a book covering manufactured according to the present invention.

FIG. 2 is a flow chart showing a process according to one embodiment of this invention.

FIG. 3 is a flow chart showing a method of determining the proper refund for books according to one embodiment of this invention.

FIG. 4 is a flow chart showing a prior art process for publishing books and issuing refunds.

FIG. 5 is a flow chart showing a process for publishing books and issuing refunds according to the present invention.

FIG. 6 is an elevational view of a product package manufactured according to the present invention.

FIG. 7 is a flowchart showing a process according to one embodiment of this invention.

FIG. 8 is a flowchart showing another process according to this invention.

FIG. 9 is an elevational view of a product manufactured according to one embodiment of this invention.

FIG. 10 is a screen press of this invention.

FIG. 11 is a flowchart showing a process according to one embodiment of this invention.

Although the figures represent certain embodiments of the present invention, the figures are not necessarily to scale and certain features may be exaggerated in order to better illustrate and explain the present invention. The exemplification set out herein illustrates certain embodiments of the invention, in one, or more forms, and such exemplifications are not to be construed as limiting the scope of the invention in any manner.

### DETAILED DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

The present invention provides a solution to problems associated with the return of merchandise to publishers and other manufacturers and retail operations. In one embodiment, the invention provides means for identifying each individual book, package or product. According to the present invention, publishers and other sellers may now confirm that each and every returned book was purchased, and at what price. Once the invention is implemented, the invention can be accomplished at little or no additional cost in terms of money, time and effort. The invention also provides an opportunity for all manufacturers and retailers to better serve their customers by providing information on purchasing activities. Thus, the invention solves a particularly vexing problem and provides an advantage, as well.

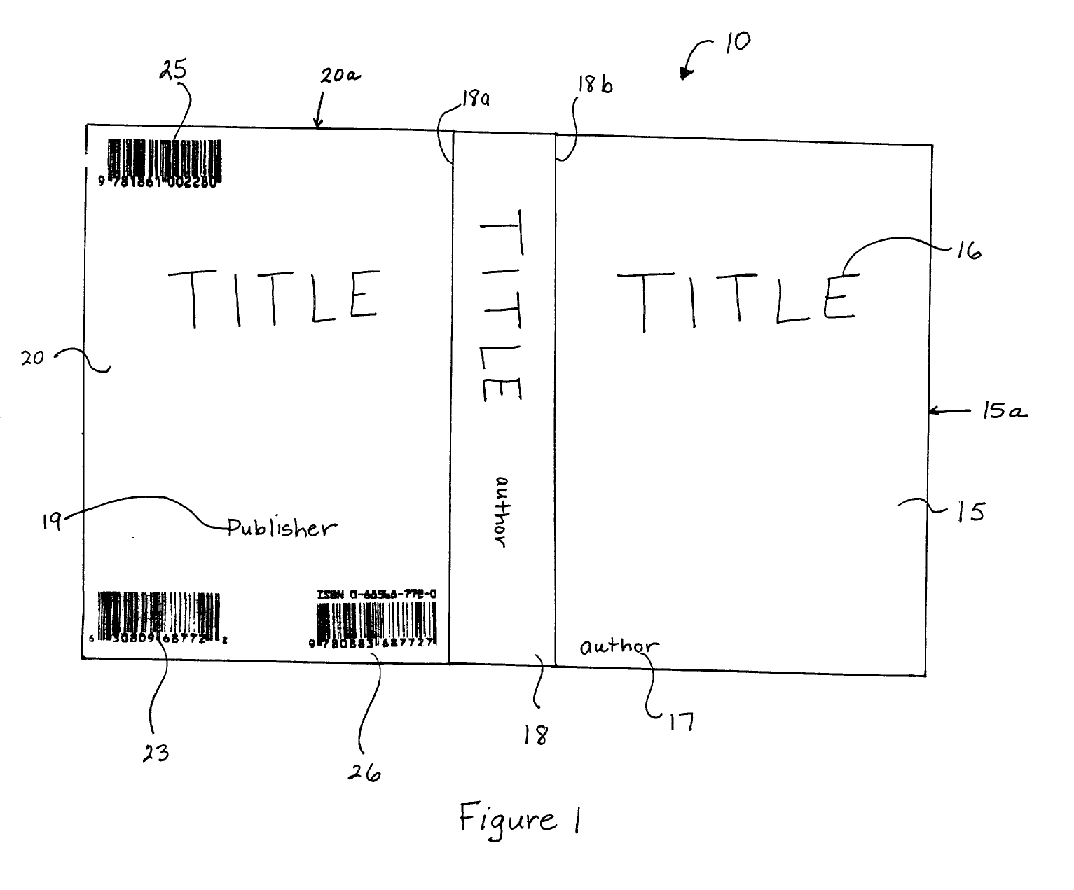

As shown in FIG. 1, the invention provides a book covering 10, which includes a front cover portion 15a and a back cover portion 20a connected to the front cover portion by a spine 18. Spine 18 has appropriate fold lines 18a, 18b as is known in the art. Both back cover portion 20a and front cover portion 15a have inner (not shown) and outer surfaces, 20, 15, respectively.

Book covering 10 includes appropriate book cover indicia, such as title 16, author's name 17 and publisher's name 19. Outer surface 20 of back cover portion 20a includes additional book cover indicia such as appropriate inventory and sales control barcodes 23, 26 as is standard in the industry. At least one unique identifier 25 is printed on book covering 10. The unique identifier correlates to information, such as for example, refund value information.

In one particular embodiment, a surface coating (not shown) is disposed over at least a portion of the front cover 15a, the spine 18, at least a portion of the back cover 20a. The coating may also be disposed over the unique identifier 25. In one particular aspect, surface coating covers outer surfaces 15, 20. The coating is any suitable coating, and such coatings are known and available. By way of example only, the surface coating may be an aqueous coating, a UV coating or a film lamination.

For the purposes of this invention, the term book covering means soft book covers, cover mounts (hard book covers) and other covers, such as dust jackets.

In one particular embodiment, the unique identifier 25 is printed on the back cover portion 20a. It is typically more aesthetically pleasing to place the unique identifier on the back cover 20a. Shoppers typically noted the spine or the front cover first, and often, will make a decision to purchase the book based upon the front cover. Shoppers typically examine the back cover for the purpose of determining the price of the book. So, in some cases, it may be preferable to place the unique identifier 25 on the back cover portion 20a of book covering 10.

In another particular embodiment, the unique identifier 25 is printed on the outer surface 20 of back cover portion 20a. Having the unique identifier on the outer surface 20 allows reading and correlating to occur without opening the book 10. This can be advantageous in high volume situations.

Unique identifier 25 may include any suitable means for uniquely identifying individual books. For example, unique identifier 25 may be a unique number, symbol, bar code or combination thereof. One advantage of using a bar code as the unique identifiers of this invention is that publishers, manufacturers and other sellers may use existing bar code reader technology. Most publishers already use barcode readers for reading inventory and sales control barcodes 23, 26. Thus, a method based upon unique bar codes can be incorporated into existing tracking systems used by publishers with minimal or no additional cost.

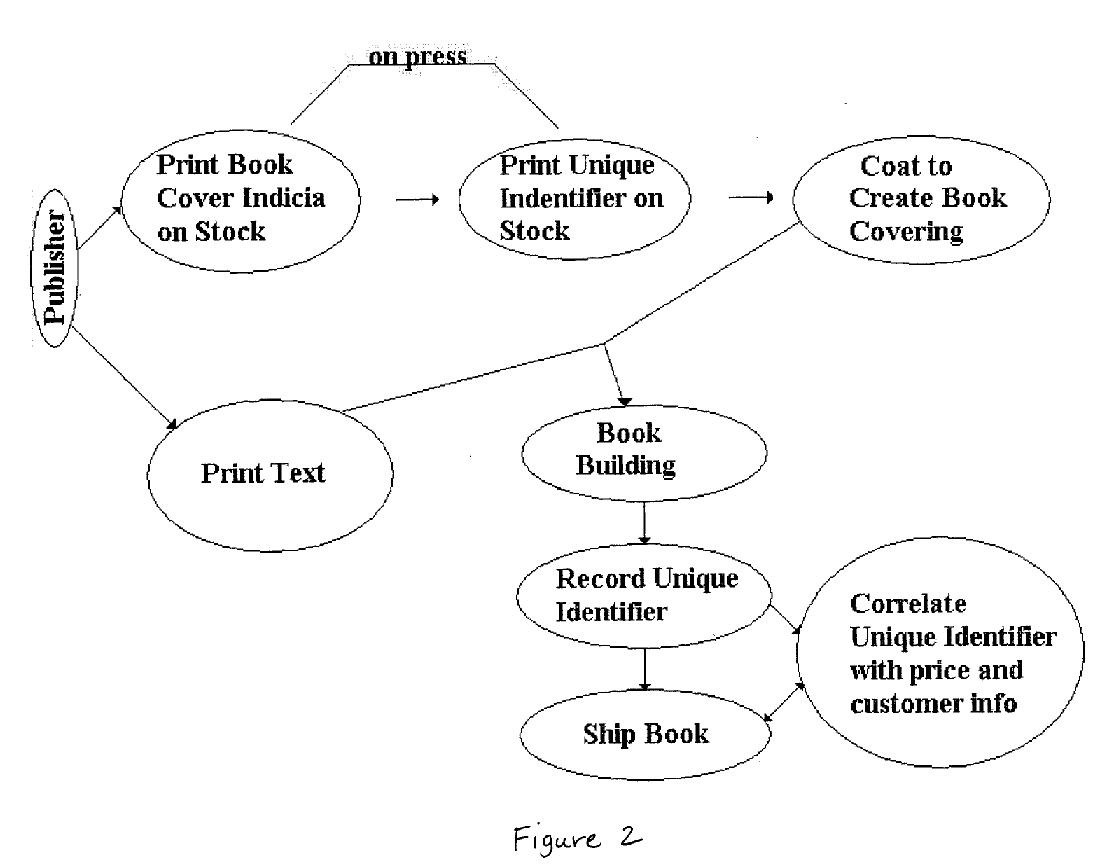

Referring now to FIG. 2, the present invention also provides methods for printing book coverings, which include providing a printing press having means for printing variable data. The means can include a variable data printing apparatus operatively engaged to the printing press. Standard printing presses can be retrofit with variable data printing devices that are commercially available. The variable data printing process becomes part of the printing process so that the unique identifiers are printed on-press, or as part of the printing process without the need for a secondary process. Any suitable press is contemplated, and such printing presses are known and commercially available. For example, the press may be sheet fed or web offset printing presses. Suitable variable data technology is commercially available, and such technology is currently used to print lottery tickets, with variable data mechanisms being retrofit onto offset sheet fed printing presses.

The methods also include employing the printing press to print book cover indicia on stock. The term stock means any natural or synthetic material that is suitable for printing book coverings, packaging or products. The stock may be in the form of single sheets for use with sheet fed presses or in the form of a web for web offset presses.

According to the invention, a unique identifier is printed on the stock during the printing processes. Using the present invention, unique identifiers can be placed on book coverings on-press, which means that an additional step or post-printing process is not required. In one embodiment, the unique identifier is printed on the back cover portion, however the unique identifier may be printed anywhere on the book. In some applications, it may be preferable to print the unique identifier on the outside of the book covering so that it is not necessary to open the book to read the identifier. In high volume situations, this will save significant amounts of time, effort and money. In still another embodiment, the unique identifier is created as a bar code 25 that can be read by standard bar code reader technology, such as is shown in FIG. 1. In some embodiments, the unique identifier is one of numbers in a sequence. In other embodiments, the numbers are created randomly, such as through the use of random number generating software, which is commercially available.

In some embodiments, after both the book cover indicia and the unique identifier is printed on the book covering, a surface coating is placed over the stock to form the book covering. The term “coating the stock” means applying a coating to a portion of the stock, such as for example, applying a coating a one side of the stock. In some cases it is beneficial to coat only the side of the stock that will become the outer surfaces of the book covering. The surface coating may be applied on-press or post-press so long as the unique identifier is printed on-press.

Of course, the invention contemplates methods for printing a run of book coverings, with each book covering 10 having a unique identifier 25 that allows each book to be distinguished from another. The same book cover indicia 16, 17, 19, 23, 26 is printed on each sheet of stock as is well known in the art. This indicia is considered to be static in that it does not change from book to book within a run. A unique identifier 25 is also printed on each sheet of the stock with the variable data printing apparatus.

In one embodiment, each sheet of stock contains a different unique identifier for each covering or package. In another embodiment, sets of stock contain the same unique identifier. Such sets are destined to become part of books that are manufactured for a particular purpose, such as for use as samples, while other sets will be offered for sale at full price. While the invention contemplates such embodiments, publishers will find that there is more flexibility in printing a different unique identifier on each book covering. In such cases the fate of each book need not be predetermined at the book covering printing stage, and a unique identifier assigned to each book reduces the possibility for fraud or unauthorized use.

In other embodiments, the stock is provided in the form of a web for use in web offset presses. As is well known in the art, the web has designated portions designated to correspond to individual book coverings. The methods include employing the printing press to print book cover indicia on the web of stock at each designated portion and printing a unique identifier on each designated portion of the stock with the variable data printing apparatus. The web is cut into individual book coverings, and the stock is then coated with a surface coating, if desired.

The type of printing press is not critical. The invention contemplates any type of printing press that can be retrofit or manufactured with variable data printing apparatus so that the unique identifier can be printed on-press. The term “on-press” means during the printing process or that which occurs in the printing line as opposed to secondary or post-press operations.

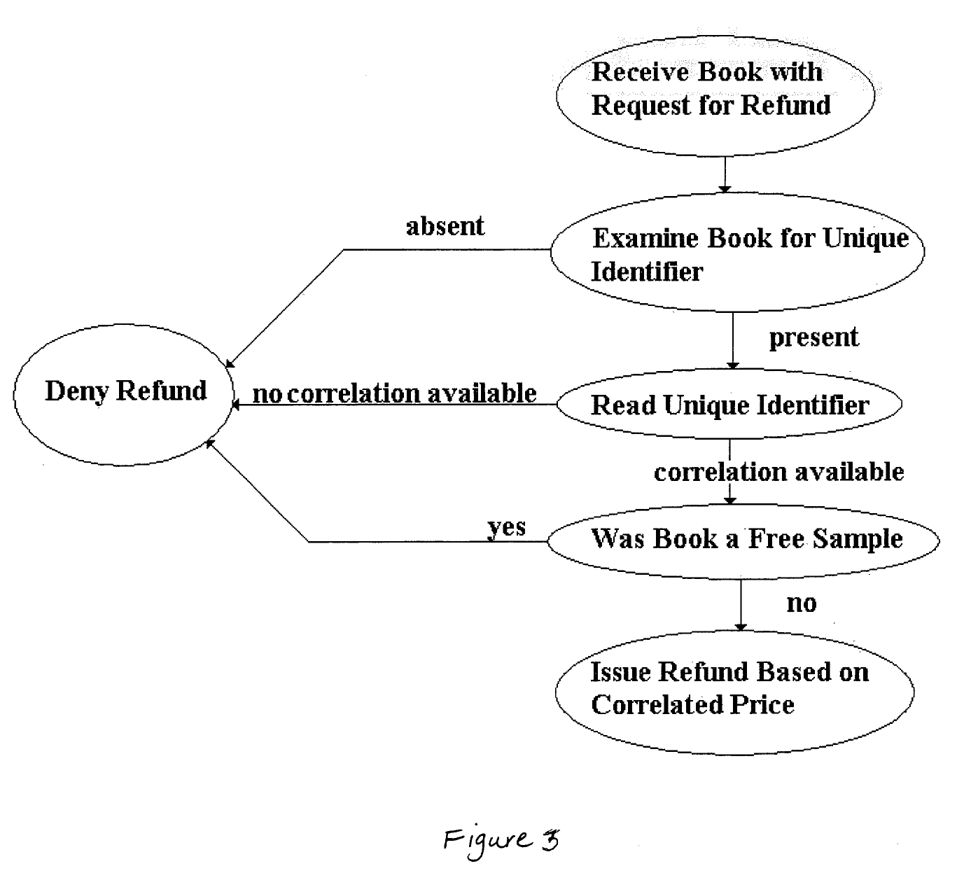

The invention also includes methods for conducting the business of publishing. In one embodiment, depicted in FIGS. 2 and 3, a method for determining whether a refund should be issued for a book is provided. The method includes the steps of providing a book covering of this invention and building the book by assembling the book covering with the text. In cases where the book covering is a book cover, the building step includes binding the book cover to text material to create a book.

The unique identifier is read, recorded and correlated with information, and the book is shipped. In this regard, the term information can include any desired information, such as for example, a specific customer name, other customer information, customer classification, price and/or payment information and refund value information. Refund value means the amount of refund that is available if the product is presented for refund. The refund value will typically relate to the purchase price of the product. In some cases, the refund value may equal the purchase price, but in other cases, the refund value may be less than the purchase price due to restocking fees or other reasons. Of course, the preceding list is not to be construed as limiting the scope of the invention.

The correlation step can occur at any time as long as the unique identifier is read and recorded before the book is shipped. This means that the price can be determined after the book is shipped and the correlation of the price and the unique identifier can occur at any time before a refund is granted or denied.

Any suitable means of receiving the data and correlating is contemplated. Existing computer databases and programs can be modified, or new ones can be created, to achieve the present invention as a routine matter without any undue experimentation. For example, existing systems store customer information, such as address, payment terms, orders, payment records, etc. These systems can be modified to correlate individual books and prices through the use of the unique identifiers of the present invention. Posting a refund to such systems will record a credit that can be applied against an existing balance due or a refund check can be generated. Implementing the methods of this invention are easily within the skill of an ordinary computer programmer or other persons of ordinary skill in the computer or software arts.

As shown in FIG. 3, upon receiving a returned book, the publisher examines the book for a unique identifier. If there is no unique identifier on the book covering, it suggests that the book may be counterfeit or pirated, and the refund is denied. This information may also be used by the publisher in making decisions about distribution channels and whether to press charges or seek civil remedies.

If a unique identifier is present, the identifier is read and correlated with information. If no correlation is available, it suggests that the unique identifier is bogus, and the refund is denied. If a correlation is available, the method includes determining whether the book was a free sample. If the book was a free sample, the refund is denied. If the book was not a free sample, the unique identifier is correlated with the purchase price and a refund is issued based on the correlated price.

The invention also contemplates correlating the unique identifier to customer information and payment information. In one embodiment, the invention includes confirming that the book was sold to the party requesting the refund. The system can deny the refund if the requesting party does not match the purchasing party. In another embodiment, the system determines whether to apply a credit against an accounts receivable or cut a refund check.

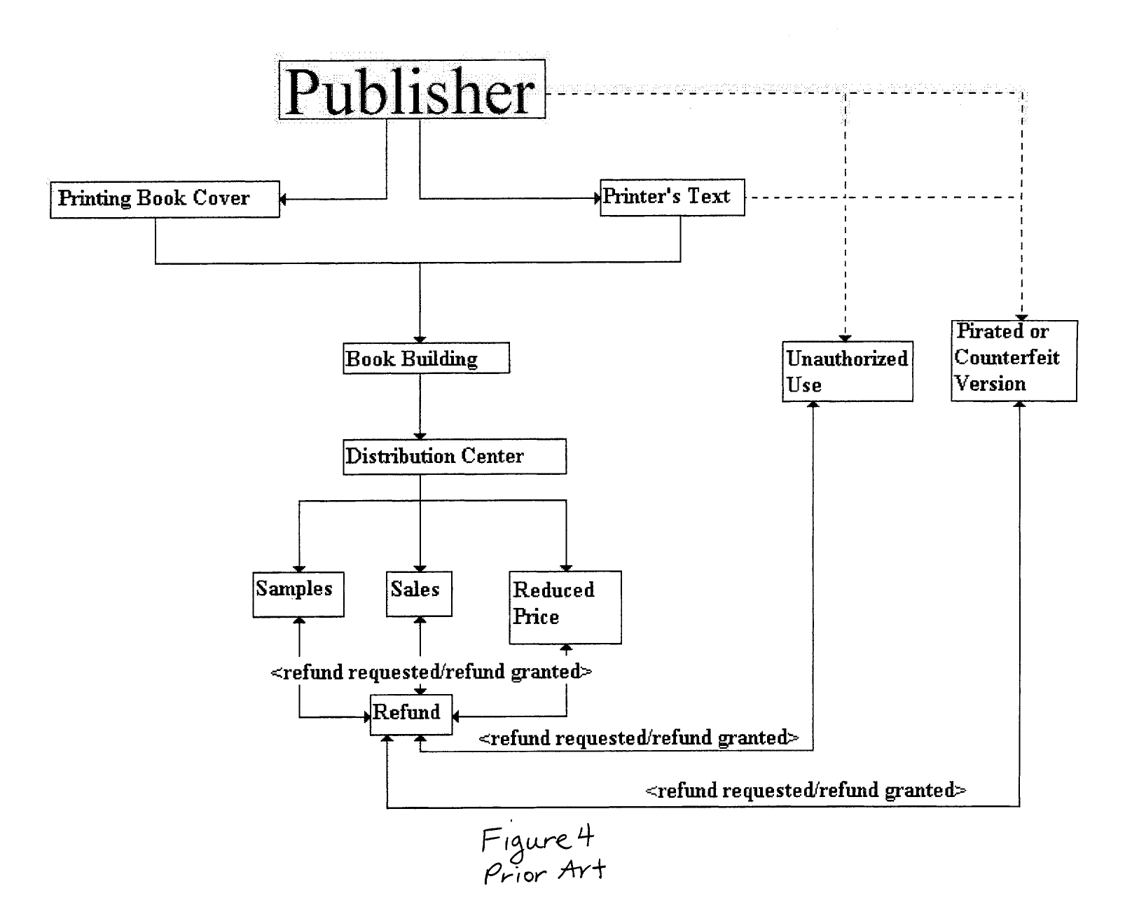

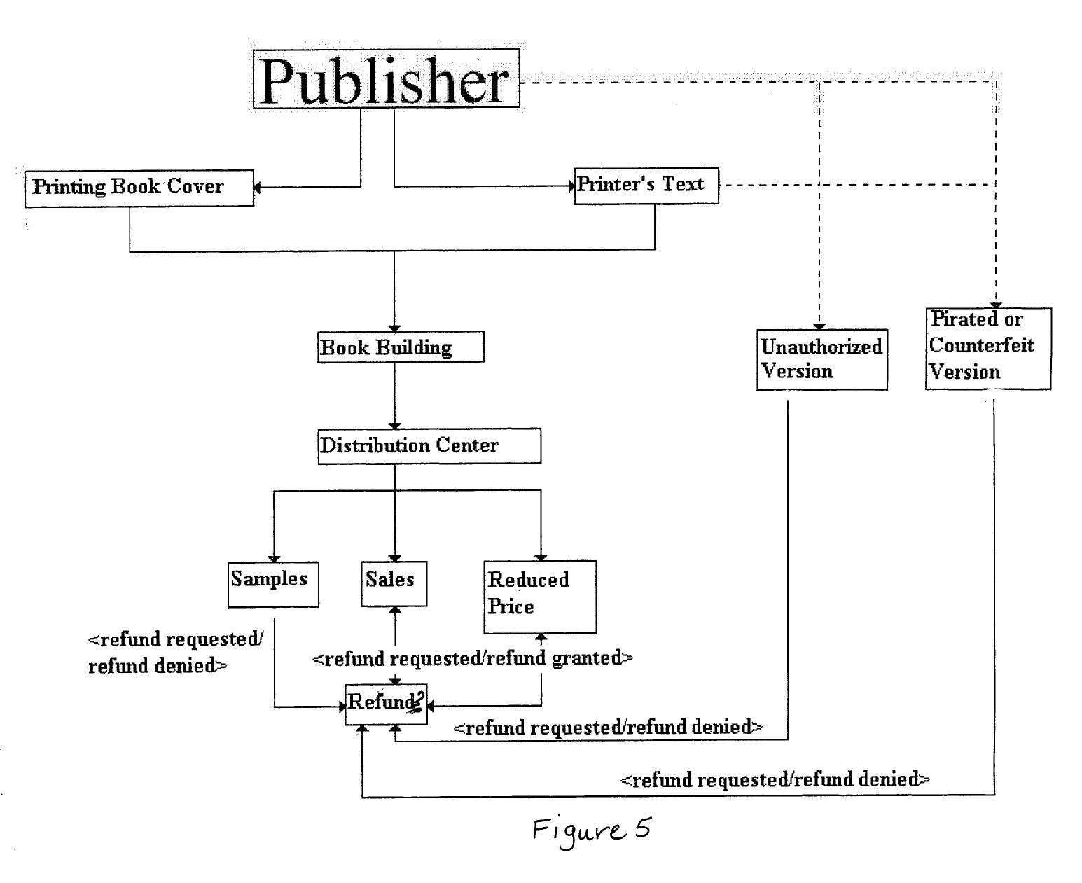

The benefits of one embodiment of this invention can be clearly seen by comparing the prior art process shown in FIG. 4 to the process shown in FIG. 5. As shown in FIG. 4, a refund is granted on all books presented for refund. The system currently cannot distinguish pirated, counterfeit and sample books from books that have been sold. Yet, in spite of this problem, to remain competitive, publishers must honor existing refund practices. Consequently, absent additional information, publishers are forced to issue refunds on these bogus refund requests.

In contrast, the process shown in FIG. 5 allows the publisher to distinguish between legitimate and bogus refund requests. In addition, the publisher can distinguish between discounted and full price books. In some embodiments, the software tracks whether the publisher has received payment for the book and whether a cash or credit refund is due. According to this invention, publishers need never again refund more than was actually paid.

The present invention provides book coverings and methods that do not require extra processing time and expense. According to this invention there is no delay in delivery of the book coverings to the text binders. The present invention is far superior to options that require additional post-printing processes, which require additional processing time. Moreover, publishers can use their existing technology to implement this invention.

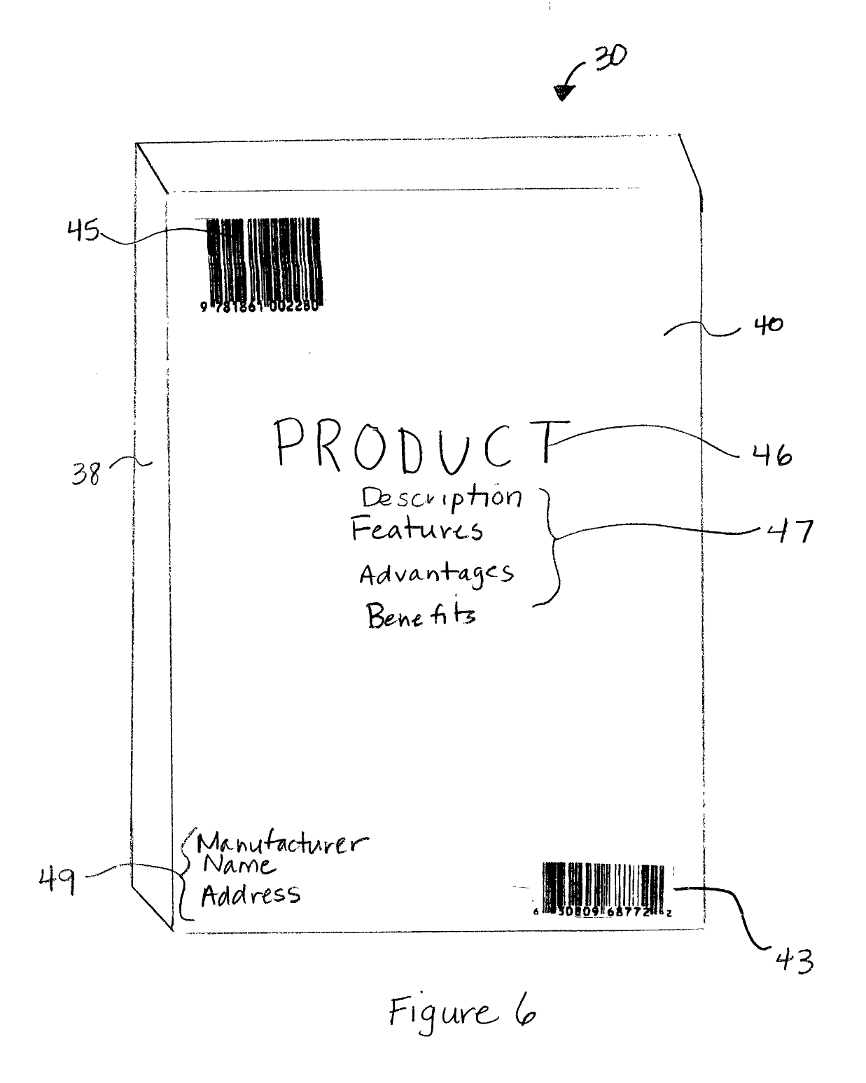

Other manufacturers and retailers will also benefit from the invention because the invention can be applied to virtually any product. For example, referring now to FIG. 6, product package 30 a front portion (not shown) and a back portion 50 connected to the front portion by a sidewall 38. The portions and sidewalls define a container for the product. Package 30 includes appropriate package indicia, such as, by way of example only, the product trademark 46, a generic description of the product as well as text describing features, advantages and benefits of the product 47 and information about the manufacturer 49. Back portion 40 includes additional product package indicia such as appropriate inventory and sales control barcodes 43, as is standard in the industry. A unique identifier 45 is printed on product package 30. In one particular embodiment, the unique identifier 45 is printed on the back portion 40. A surface coating (not shown) is disposed over the front portion, the sidewall 38, the back portion 40 and the unique identifier 45. Any suitable surface coating is contemplated, and such coatings are known and readily available.

Unique identifier 45 may include any suitable means for uniquely identifying individual product units. For example, unique identifier 45 may be a unique number, symbol, bar code or combination thereof. One advantage of using a bar code as the unique identifiers of this invention is that many manufacturers, distributors and retailers already use existing bar code reader technology. Thus, a method based upon unique bar codes can be incorporated into existing used by manufacturers, distributors and retailers without additional cost.

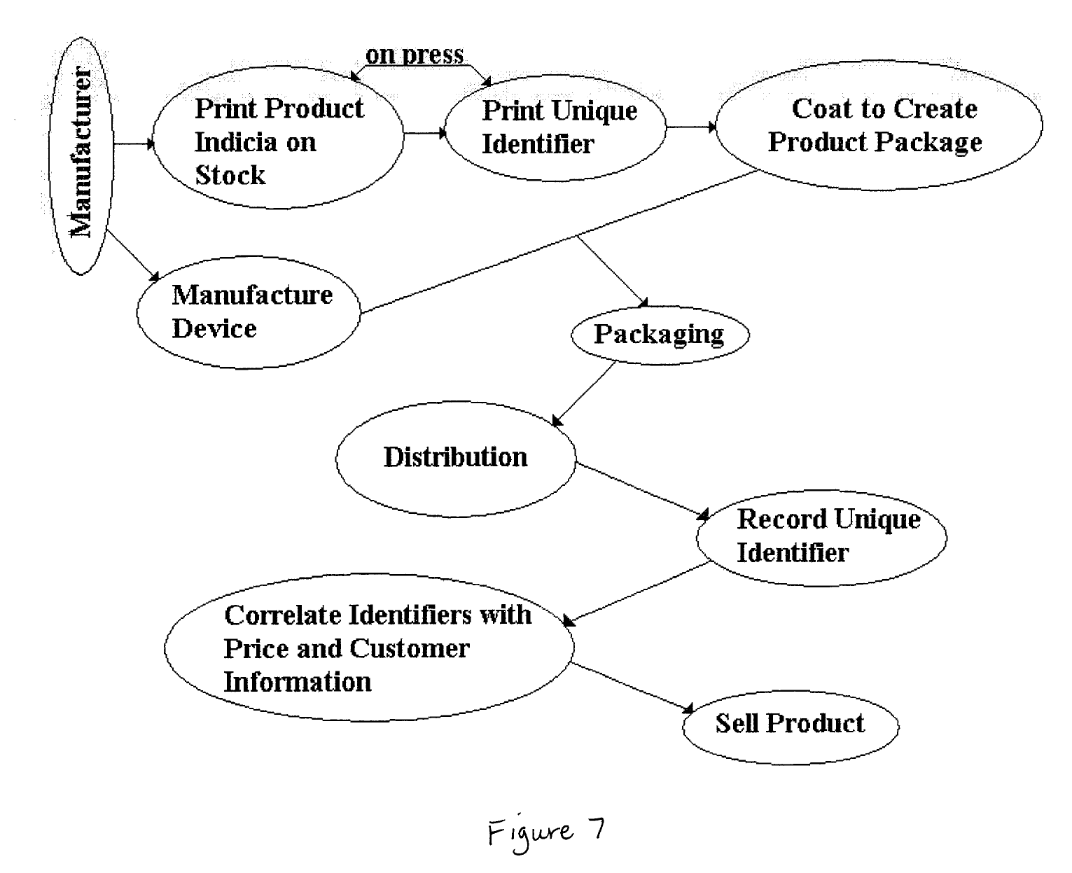

Referring now to FIG. 7, the present invention also provides methods for printing product packaging, which include providing a printing press having on-press means for printing variable data. Product packaging indicia is printed on stock or other suitable media. The stock may be in the form of single sheets for use with sheet fed presses or in the form of a web for web offset presses. A unique identifier is printed on the stock during the printing process as described above for books. After both the product packaging indicia and the unique identifier are printed on the package, a surface coating can be placed over the stock. The product package can then be folded and assembled as needed to form a container for goods.

After the goods are packaged within the packaging to form a product, the product is distributed. At each step in the chain, the unique identifiers may be recorded and correlated with information, such as warehouse location, date in and date out, for example. When products are distributed to the retail facilities, additional information can be correlated, such as date in, store location, etc. When a customer purchases the product, the unique identifier is read and correlated with the sales price and in some cases, customer name, address and other information.

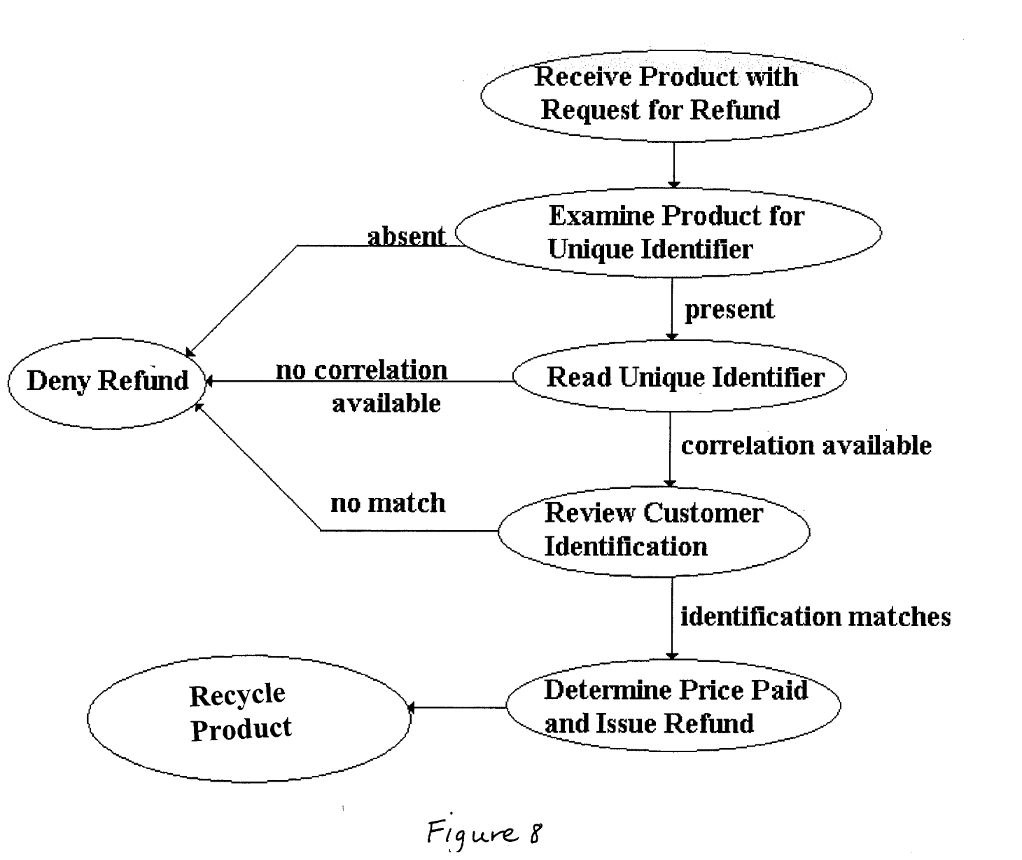

In one embodiment, depicted in FIG. 8, a method for determining whether a refund should be issued for a product is provided. When a customer presents a product for refund, the retailer examines the product for a unique identifier. If there is no unique identifier on the product package, it suggests that the product may be counterfeit or pirated, and the refund is denied. If a unique identifier is present, the identifier is read and correlated with information. If no correlation is available, it suggests that the unique identifier is bogus or that the product was stolen, and the refund is denied. If a correlation is available, the unique identifier is correlated with the purchase price. In some cases, the customer identification is reviewed and compared to customer information related to the unique identifier. It may be desirable to correlate customer information such as name, address and driver's license number in case a problem with the returned product is found later. A refund is issued based on the correlated price. The product can then be inspected and recycled, such as by returning it to the sales floor or the manufacturer.

The invention also contemplates correlating the unique identifier to customer information and payment information. In one embodiment, the invention includes confirming that the product was sold to the party requesting the refund. The system can deny the refund if the requesting party does not match the purchasing party. In another embodiment, the system determines whether to apply a credit refund or issue a refund in the form of cash or a check.

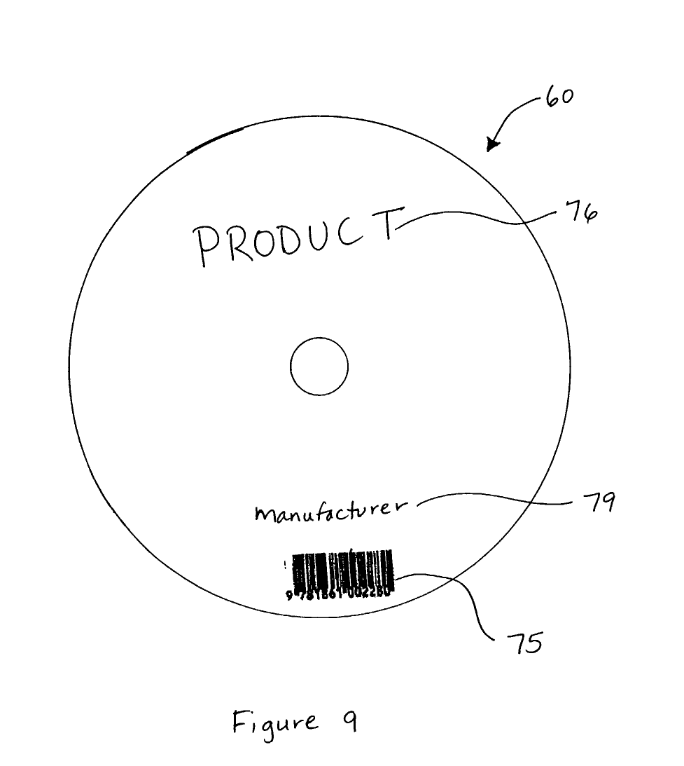

The present invention can also be used to identify individual products as shown in FIG. 9. Products such as disc 60 can be printed with at least one unique identifier 75 of this invention before packaging. According to prior art methods, such products are now currently labeled with a post-print sticker or are left unidentified. Disc 60 may be a cd-rom, cd-recordable, musical cd, dvd, laser disc, floppy discs or other suitable media that is printed before packaging. Disc 60 may include appropriate product indicia and graphics, such as, by way of example only, the product trademark 76 and information about the manufacturer 79.

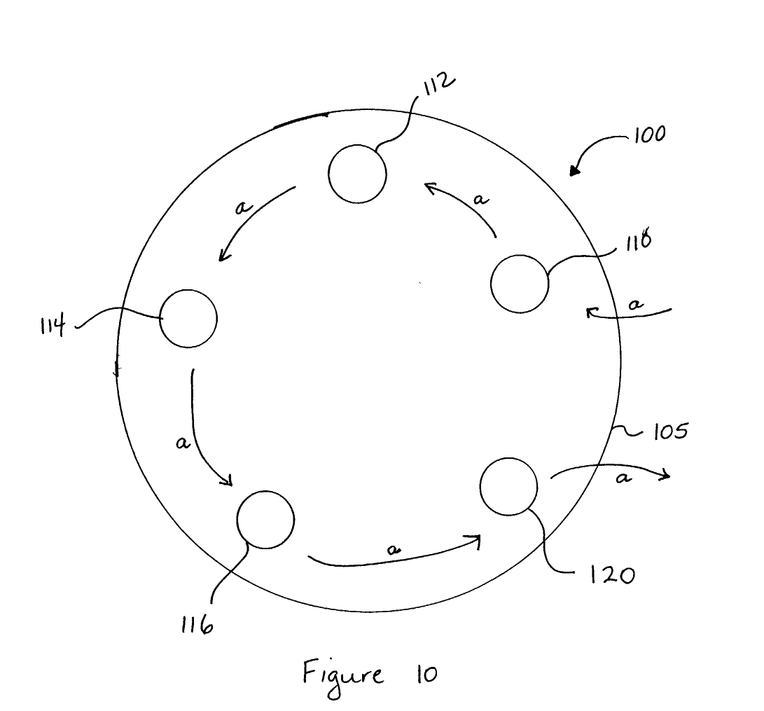

Disc 60 can be manufactured according to this invention as described above so that the unique identifier 75 is printed on-press. A screen press 100 having means for printing variable data according to one embodiment of this invention is shown in FIG. 10. Screen press 100 includes a rotatable table 105 disposed under color stations 110, 112, 114, 116, which apply color according to a predetermined pattern to the disc, as is known in the art. The disc rotates on the table 105 in the direction of the arrows a. Variable data printing apparatus 120 is operatively engaged to the screen press. Standard screen presses can be retrofit with variable data printing devices that are commercially available. The variable data printing process becomes part of the printing process so that the unique identifiers are printed on-press, or as part of the printing process without the need for a secondary process. Any suitable screen press is contemplated, and such printing presses are known and commercially available.

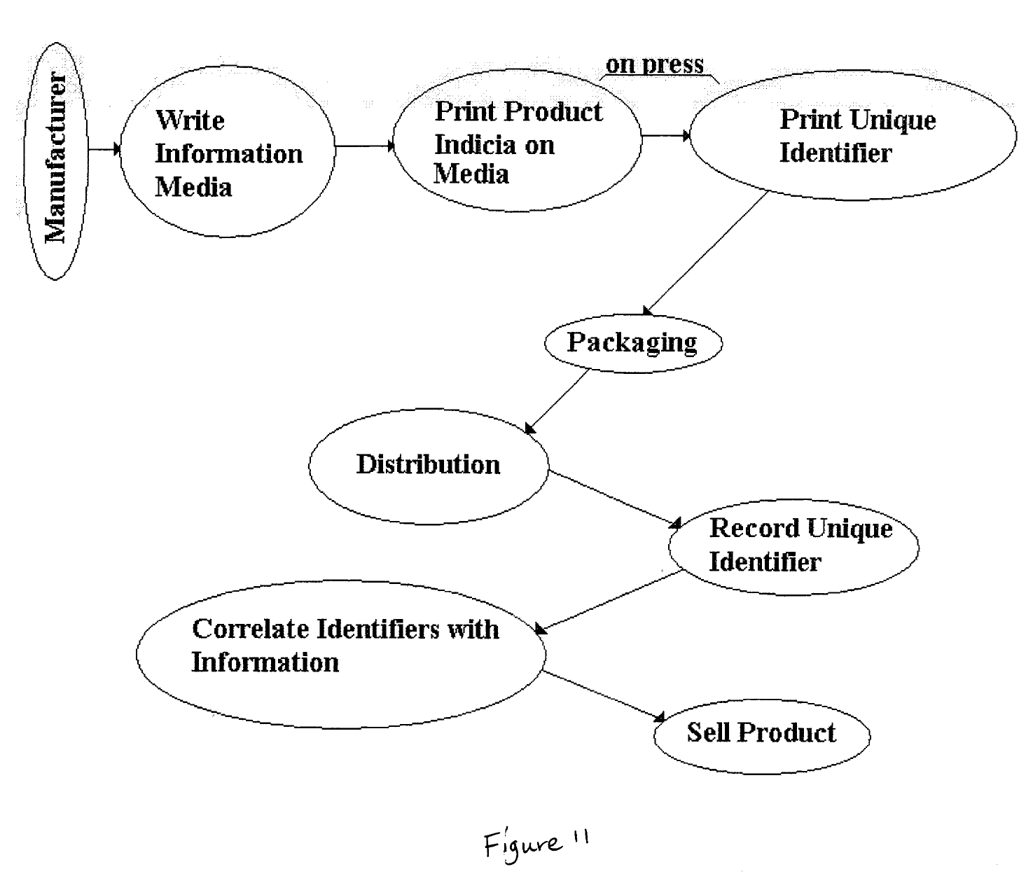

The process of this embodiment is shown in FIG. 11. The process includes writing information, such as music or a program, on the media. Product indicia and at least one unique identifier are then printed on the media. The remaining steps have been described above and are also shown in FIG. 8.

The present invention is particularly useful with high end products such as computer software and power tools. There are several advantages to the methods of this invention. For example, manufacturers and retailers can better manage turn over of products. Using computer software, it is possible to determine the exact location of individual pieces. In addition, publishers, retailers and manufacturers can obtain information about customers and market demographics. Retailers can make their good customers happier by allowing refunds without a receipt. According to prior art methods, products presented for refund without a receipt are typically refunded at the lowest recent sale price. Customers who paid a higher price are understandably unhappy. The invention is also convenient for gift returns and make the prior art “gift receipts” unnecessary.

The invention will also reduce or eliminate the certain fraudulent return practices. In many cases, the retailer or manufacturer provides a refund only to learn later that the product package does not contain the product or that the product has suffered a great deal of wear and tear. Since the unique identifier can be correlated with the name, address and license number of the party returning the product, this invention will be a deterrent to such fraudulent activities.

Other embodiments of the invention will be apparent to those skilled in the art from consideration of the specification and practice of the invention disclosed herein. It is intended that the specification, drawings and examples be considered as exemplary only, with the true scope and spirit of the invention being indicated by the following claims. For example, while the specification refers to the use of computers to implement this invention, it should be understood that the reading and correlation portions of this invention could be accomplished manually. It should be understood that only the preferred embodiments have been shown and described and that all changes and modifications that come within the spirit of the invention are desired to be protected.

What is claimed:

1. A book covering, comprising:
a front cover portion and a back cover portion connected to said front cover portion by a spine; and
a unique identifier printed on the book covering wherein said unique identifier includes a bar code.

2. The book covering of claim 1 wherein said unique identifier is printed on said back cover portion.

3. The book covering of claim 1 wherein said unique identifier is printed on an outer surface of said back cover portion.

4. The book covering of claim 1 further comprising a surface coating disposed over at least a portion of said front cover, at least a portion of said spine, at least a portion of said back cover and said unique identifier.

5. The book covering of claim 4 wherein said surface coating is a film lamination.

6. A method for printing a book covering, the book covering having a front cover portion and a back cover portion connected to the front cover portion by a spine, the method comprising the steps of:
providing a printing press having means for printing variable data;
employing the printing press to print book cover indicia on stock; and
printing at least one unique identifier on the stock with the means.

7. The method of claim 6 wherein the means is a variable data printing apparatus operatively engaged to the printing press.

8. The method of claim 7 wherein the printing step includes printing the unique identifier on the back cover portion.

9. The method of claim 7 wherein the printing the unique identifier includes printing a bar code.

10. The method of claim 7 further comprising the step of:
coating the stock with a surface coating after the employing step and the printing step.

11. The method of claim 10 wherein the coating step includes laminating the stock with film.

12. A method for printing a run of book coverings, each book covering having a front cover portion and a back cover portion connected to the front cover portion by a spine, the method comprising the steps of:
providing a printing press assembly having a printing press and a variable data printing apparatus operatively engaged to the printing press;
providing sheets of stock employing the printing press to print book cover indicia on each sheet of stock; and
printing at least one unique identifier on each sheet of the stock with the variable data printing apparatus.

13. The method of claim 12 wherein the printing step includes printing the unique identifier on the back cover portion.

14. The method of claim 13 wherein the printing step includes printing a bar code.

15. The method of claim 12 wherein the printing step includes printing a bar code.

16. A method for printing a run of book coverings, each book covering having a front cover portion and a back cover portion connected to the front cover portion by a spine, the method comprising the steps of:
providing a printing press assembly having a printing press and a variable data printing apparatus operatively engaged to the printing press;
providing a web of stock, the web having designated portions designated to correspond to individual book coverings;
employing the printing press to print book cover indicia on the web of stock at each designated portion; and
printing at least one unique identifier on each designated portion of the stock with the variable data printing apparatus.

17. A method for determining whether a refund should be issued for a book, comprising the steps of:
providing a book covering, the book covering having
a front cover portion and a back cover portion connected to the front cover portion by a spine, and
a unique identifier printed on the book covering, the unique identifier including a bar code;
assembling the book covering with text material to create a book;
recording the unique identifier;
correlating the unique identifier with information;
shipping the book after the recording step; and
upon receiving a returned book, determining the amount of refund to issue, if any, based upon the information correlated with the unique identifier.

18. The method of claim 17 wherein the shipping step occurs after the correlating step.

19. The method of claim 17 further comprising correlating the unique identifier to customer information.

20. The method of claim 17 further comprising correlating the unique identifier with payment information.

21. A product package, comprising:
a front portion, a back portion and a side wall connecting said front portion to said back portion to define a container for a product; and
a unique identifier printed on at least one of said front portion, said back portion and said side wall, wherein said unique identifier includes a bar code.

22. A method for printing a product package, comprising the steps of:
providing a printing device;
providing a variable data printing apparatus operatively engaged to the printing device;
employing the printing device to print product package indicia on stock; and
printing at least one unique identifier on the stock with the variable data printing apparatus.

23. A method for determining whether a refund should be issued for a product, comprising the steps of:
providing a product package, the product package having
a front portion, a back portion and a side wall connecting the front portion to the back portion to define a container for a product; and
a unique identifier printed on at least one of the front portion, the back portion and the side wall, wherein the unique identifier includes a bar code;
packaging goods within the product package to create a product;
recording the unique identifier;
correlating the unique identifier with information;
shipping the product after the recording step; and
upon receiving a returned product, determining the amount of refund to issue, if any, based upon the information correlated with the unique identifier.

24. A book covering for a book, comprising:
a front cover portion and a back cover portion connected to said front cover portion by a spine; and
a unique identifier printed on the book covering, said unique identifier correlating to a refund value for the book.
